(19) United States
(12) Patent Application Publication
(10) Pub. No.: US 2003/0117091 A1
(43) Pub. Date: Jun. 26, 2003

(54) Power saving supply commutation method and apparatus for electronic convergence circuits

(75) Inventors: David A. Christian, Fort Wayne, IN (US); James R. Jennings JR., Knoxville, TN (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/028,379

(22) Filed: Dec. 21, 2001

(51) Int. Cl. G09G 1/04

(52) U.S. Cl. 315/387

(57) ABSTRACT

In accordance with an exemplary embodiment of the present invention, a cathode ray tube convergence circuit includes a low voltage power supply and a high voltage power supply. The cathode ray tube convergence circuit further includes a switching network which is adapted to switch between the low voltage power supply and the high voltage power supply. The switching network dissipates substantially no power during operation of the convergence circuit.

### BACKGROUND AND SUMMARY OF THE INVENTION

1) Field of the Invention

The present invention pertains to amplifier circuits for cathode ray tubes, and more particularly, to an electronic convergence circuit which reduces power loss in cathode ray tube devices.

2) Description

Cathode ray tubes are commonly used in televisions and other imaging devices. Cathode ray tubes are often subject to distortions of the video image on the cathode ray tube faceplate raster. Such distortions include east-west pin distortion, north-south pin distortion, horizontal non-linearality, and vertical non-linearality. Projection televisions use a bent lightpath, consisting of a mirror and viewing screen, to enlarge the raster image. The lightpath not only magnifies these raster distortions, but also add new distortions. These include horizontal and vertical trapezoid distortion, skew and bow. If left uncorrected, the resultant picture is highly distorted. Correcting for these distortions has proven difficult. The distortion present for each of the three colors (red, blue, green) is different because the lightpath cathode ray tube to screen alignment is different for each color.

One known technique used to attempt to correct these distortions employs auxiliary deflection yokes which are commonly referred to as convergence yokes. Each convergence yoke further includes horizontal and vertical coils.

The voltage requirements for beam deflection during scanning are markedly different during the trace and retrace intervals of each horizontal scan. To wit, during the trace interval, relatively low voltages and currents are used to drive the coils. However, during the retrace interval, a relatively high voltage and current combination is used. It is noted that the trace interval generally accounts for more than three-fourths of the operation time of the tube.

While conventional convergence circuits have aided in mitigating distortion in cathode ray tubes, there are significant drawbacks associated with these conventional approaches. For example, the conventional convergence yoke circuits which incorporate a dual power supply approach often waste power at some stage of the convergence circuit, typically at the switching network stage of the circuit. To this end, these conventional dual supplies provide a substantially constant amount of power to this circuit. A portion of this power is dissipated at some unused stage of the circuit in order to provide the lower voltage during the trace interval of the horizontal scan. As such, the attendant problems of wasted power have been addressed with limited success by these conventional convergence circuits.

What is needed, therefore, is a conversion circuit for use in cathode ray tubes which overcomes at least the drawbacks of conventional convergence circuits described above.

In accordance with an exemplary embodiment of the present invention, a cathode ray tube convergence circuit includes a low voltage power supply and a high voltage power supply. The cathode ray tube convergence circuit further includes a switching network which is adapted to switch between the low voltage power supply and the high voltage power supply. The switching network dissipates substantially no power during operation of the convergence circuit.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a schematic block diagram of a convergence circuit in accordance with an exemplary embodiment of the present invention.

FIG. 2 is a schematic diagram of a convergence circuit with positive power supplies in accordance with an exemplary embodiment of the present invention.

FIG. 3 is a schematic diagram of a convergence circuit with negative power supplies in accordance with an exemplary embodiment of the present invention.

FIG. 4 is a tabular representation of measured commutated output section supply power consumption in a convergence circuit in accordance with an exemplary embodiment of the present invention.

FIG. 5 is a diagram of the power supply response of a convergence circuit in accordance with an exemplary embodiment of the present invention.

### DESCRIPTION OF THE PREFERRED EMBODIMENTS

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

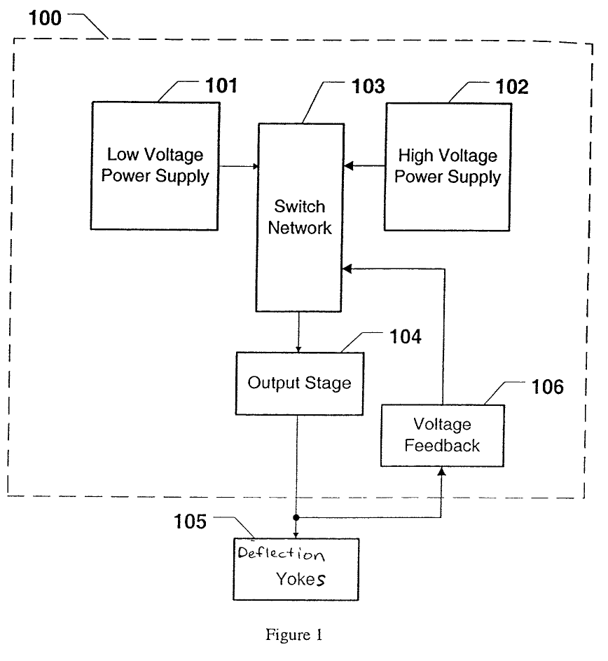

Turning to FIG. 1, a conversion circuit 100 for use in cathode ray tubes (e.g. television tubes, projection televisions, etc.) is shown. The conversion circuit 100 includes a low voltage power supply 101, and a high voltage power supply 102. The low voltage power supply 101 and high voltage power supply 102 are connected to a switching network 103. The switching network 103 is connected to a output stage 104, which is ultimately connected to deflection yokes 105 disposed about the cathode ray tube (not shown). The deflection yokes 105 include standard deflection yokes and convergence yokes. A voltage feedback circuit 106 provides the voltage sense and magnitude detection to control the switching network 103.

In accordance with an exemplary embodiment of the present invention, the low voltage power supply operates in the range of approximately 12V to approximately 24V and at a current of up to 1 A. Moreover, the high voltage power supply 102 operates in the range of approximately 24V to approximately 40V and at a current of up to 1 A. Of course, the low and high voltage power supplies 102 and 103 each are adapted to operate at both positive and negative polarities (i.e. positive and negative voltages). The switching network 103 usefully provides either the low voltage power supply 101 or the high voltage power supply 102 to the output stage 104, and ultimately to the deflection yokes 105.

As referenced previously, according to an exemplary embodiment of the present invention, during the majority of the scan period, the low voltage power supply 101 supplies a lower voltage to the standard deflection yokes. Only during the period when the need for a higher voltage is detected will a higher voltage be supplied to the convergence yokes to mitigate distortion effects. Of course, these are merely illustrative uses of the convergence circuit of the present invention and it is noted that the present invention may be used in other applications.

As can be appreciated, the convergence circuit 100 in accordance with an exemplary embodiment of the present invention supplies only the necessary power to the deflection yokes 105 in operation. As such, very little power is wasted, and in addition to a savings in power consumption, significant reductions in the requirements for heat sinks and other power-related elements (e.g. power transistors) are required. This is a direct result of the convergence circuit 100 of the exemplary embodiment shown in FIG. 1. To wit, the low voltage power supply 101 and the high voltage power supply 102 are engaged only as needed. In fact, only power from the engaged power supply passes through the switching network. Thereby, excess power which is dissipated in various elements (e.g., in switching elements) in conventional devices is not provided to the circuit.

Finally, it is noted that the trigger for switching between the low voltage power supply 101 and the high voltage power supply 102 is provided through the sensing of the output voltage and making a comparison to a predetermined threshold voltage. Voltage feedback 106 connects the output voltage supplied to the deflection yokes 105, attenuating the voltage to within the proper level for a comparator circuit (not shown). The comparator circuit is a well-known method featuring an open-collector output and feedback hysteresis to improve switching. It is noted that the presently described technique for triggering the switching network between the low voltage power supply 101 and the high voltage power supply 102 is merely one example of how to meet this end. Other techniques/circuits within the purview of the artisan of ordinary skill could be used in keeping with the present invention.

As will become more clear as the detailed description proceeds, while there are a variety of possible techniques for achieving a reduction in power dissipation in keeping with the present invention, one practical method is described in detail for the purpose of illustration. It is specifically noted that this technique is illustrative of the present invention, and is in no way limiting thereof.

One method to reduce power dissipation in accordance with an exemplary embodiment of the present invention is through the use of divided rails. Illustratively, the use of divided rails comprises supplying power to the output devices of a convergence circuit from a set of supply rails regulated to approximately half of the maximum required voltage. The supply rails are switched (e.g. by a switching network such as switching network 103) to the maximum value only when needed. Because the convergence circuits operate approximately two-thirds to three-fourths of the time in the low power mode, a power dissipation reduction of approximately 50% is realized when compared to conventional convergence circuits.

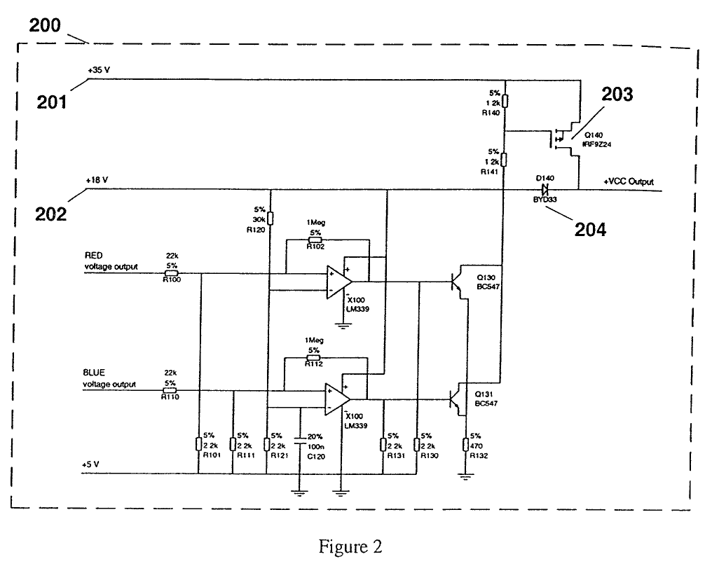

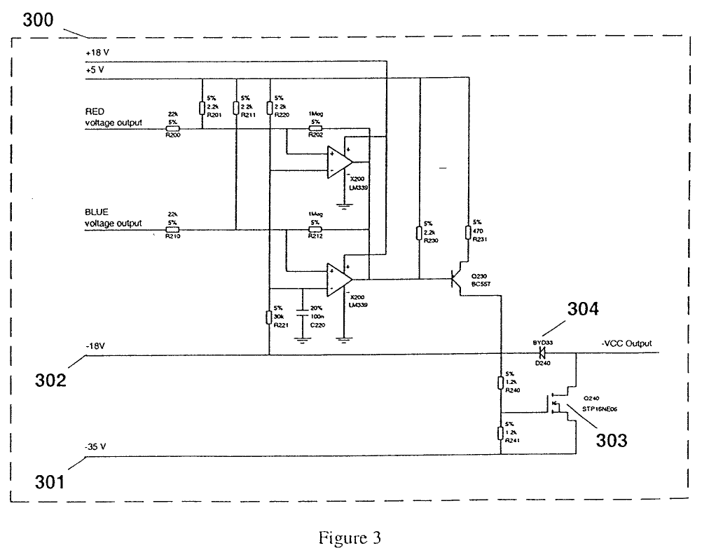

FIGS. 2 and 3 show an illustrative divided rail circuit which may be incorporated into the convergence circuit 100 for use in the low voltage power supply 101, the high voltage power supply 102, and the switching network 103. To this end, complementary schematic diagrams of a divided rail structure for use as low and high voltage power supplies in accordance with an illustrative embodiment of the present invention include a positive polarity convergence circuit 200 and a negative polarity convergence circuit 300. As will become more clear as the description of the present invention proceeds, the positive polarity convergence circuit 200 outputs both the high and low positive voltage, and effects switching; and the negative polarity convergence circuit 300 outputs both the high and low negative voltage source, and effects switching. Because of the complementary nature of the positive and negative polarity convergence circuits 200 and 300, respectively, a detailed discussion of both circuits would be redundant. As such, in the interest of brevity positive polarity convergence circuit 200 will be described in detail, and any counterpart element or parameter of the negative polarity convergence circuit will be identified parenthetically.

In the exemplary embodiment shown in FIG. 2 (FIG. 3), a positive polarity convergence circuit 200 (300) includes a first rail on node 201 (301) and a second rail on node 202 (302). The first rail illustratively operates at a voltage of +18V (−18V). For purposes of illustration, it is noted that the first rail may operate in a range of approximately +12V (−12V) to approximately +24V (−24V). The second rail illustratively operates at a voltage of +35V (−35V); although it is noted that the second rail may operate in the illustrative range of approximately +24V (−24V) to approximately +40V (−40V). As the power supplies of divided rails are readily understood by one having ordinary skill in the art, the known details will be omitted for purposes of brevity of discussion, and only the features of the invention will be described in detail.

The positive polarity and negative polarity convergence circuits 200 and 300, respectively, may be used in accordance with the exemplary embodiment shown in FIG. 1 to achieve what is often referred to as a boost-on-demand (BOD) circuit. First and second transistors 203 and 303, and diodes 204 and 304 illustratively comprise the power switching elements of a switching network 103. The first and second transistors 203 and 303 are illustratively field effect transistors (FET's) with low on-resistance (Rₒₙ), and do not require large heat sinks, as a result. The first transistor 203 illustratively has an on-resistance (Rₒₙ) of less than 0.1 Ω with a current capacity of 16A. Second transistor 303 illustratively has a Rₒₙ of less than 0.175 Ω with a current capacity of 12A. Both transistors are switched relative to respective second rails. When first (or second) transistor 203 (or 303) is not turned on, diode 204 (or 304) supplies power from the first rail to the output stage 104 of FIG. 1. When the first (or second) transistor 203 (or 303) is turned on, power to the output stage is supplied from the second rail; and diode 204 (or 304) is reversed biased and blocks the connection to the first rail.

In accordance with exemplary embodiments of the present invention, the switching network does not dissipate a significant amount of power during operation. This is primarily due to the low on resistance and high power rating of first and second transistors 203 and 303. As referenced previously, conventional linear power supply circuits used in convergence circuit applications dissipate significant power levels in voltage boost switching elements (i.e. conventional switching networks). To wit, in conventional convergence circuits, a portion of the power dissipation is transferred from output stage to the switching network. As such, these conventional switching elements must have a heat sink significantly large to limit internal junction temperatures within the component specifications, which translates to heat sinks which may take up a significant amount of board space. As can be readily appreciated by one having ordinary skill in the art, this results in size and price penalties which ultimately may be unacceptable. Moreover, performance issues may arise from the excessive heating as well.

In contrast, by virtue of positive and negative polarity convergence circuits 200 and 300, respectively, of the present exemplary embodiment, the first and second transistors 203 and 303 dissipate less than 200 milliwatts of power, which represents a substantial improvement over the conventional convergence circuit power supplies. Ultimately, this fosters improved performance, reduced supply circuit size, and reduced price.

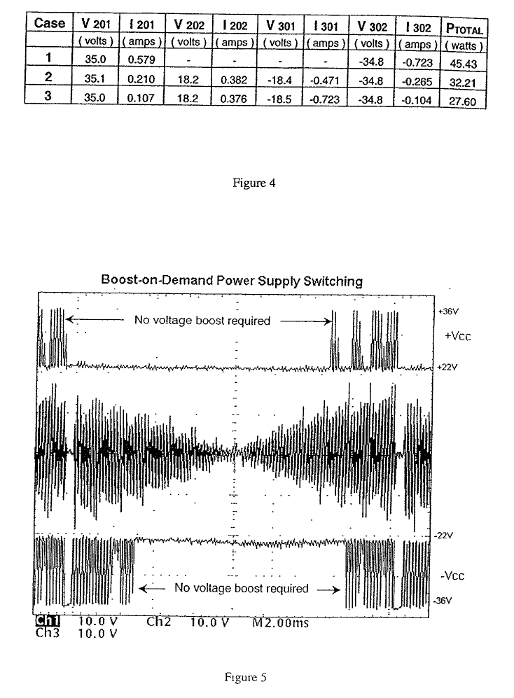

For purposes of illustration, experimental data which resulted from the use of the combined positive and negative polarity convergence circuits 200 and 300 in accordance with the exemplary embodiment shown in FIG. 1, is shown in FIG. 4.

In the data shown in FIG. 4, Case 1 illustrates the various voltages, currents and power drawn (i.e. power dissipation) of a convergence circuit without a voltage boost. Case 2 comprises measurements of the same parameters using a convergence circuit of the illustrative embodiment of the present invention to boost the power supplies only during the horizontal retrace interval. Case 3 is an exemplary measurement using the positive and negative polarity convergence circuits 200 and 300 in a typical projection television application.

FIG. 5 shows the waveforms associated with this embodiment incorporating the positive and negative polarity convergence circuits 200 and 300 in convergence circuit 100. To this end, this graph of voltage vs. time demonstrates the switched +V_{cc} and −V_{cc} power supplies with a periodic complex waveform used as the input to the boost-on-demand circuit. As can be readily appreciated from a review of FIG. 5, the boost-on-demand requires no voltage boost for a significant portion of time. During this period, the output voltage is ±22V. However, as required, the boost-on-demand circuit provides the higher voltage output (±36V in this case) as shown.

The convergence circuits in accordance with the exemplary embodiments of the present invention permit greater power saving than are available using conventional techniques. The present invention enables switching integrated circuits and transistors to be incorporated with reduced heat sinks, or even no heat sinks. Ultimately, the power savings and reduction in material and design cost are particularly advantageous in a variety of applications of cathode ray tubes.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

What is claimed is:

1. A cathode ray tube convergence circuit, comprising:
A low voltage power supply;
A high voltage power supply; and
A low-power dissipating switching network which switches between said low voltage power supply and said high voltage power supply.

2. A cathode ray tube convergence circuit as recited in claim 1, wherein power dissipation of said low-power switching network is in the range of approximately 25 Watts to approximately 50 Watts.

3. A cathode ray tube convergence circuit as recited in claim 1, wherein low voltage power supply operates between approximately 12V and approximately 24V.

4. A cathode ray tube convergence circuit as recited in claim 1, further comprising a divided rail circuit.

5. A cathode ray tube convergence circuit as recited in claim 1, wherein said low voltage power supply drives a standard deflection yoke of the cathode ray tube.

6. A cathode ray tube convergence circuit as recited in claim 1, wherein said high-voltage power supply drives a convergence yoke during a retrace interval of the cathode ray tube.

7. A cathode ray tube convergence circuit as recited in claim 1, wherein an output stage receives a power from one of said power supplies at a particular time, and a power from the other of said power supplies does not traverse said switch network at said particular time.

8. A cathode ray tube convergence circuit as recited in claim 1, wherein said switching network further comprises at least one field effect transistor which dissipates less than approximately 200 mW of power.

9. A cathode ray tube convergence circuit as recited in claim 1, wherein said switching network further includes transistors and diodes.

10. A cathode ray tube convergence circuit as recited in claim 1, wherein the convergence circuit drives convergence yokes of the cathode ray tube.

11. A cathode ray tube convergence circuit as recited in claim 1, further comprising a voltage feedback circuit to initiate said switching.

12. A cathode ray tube convergence circuit, comprising:
A boost-on-demand circuit which includes a positive polarity convergence circuit, and a negative polarity convergence circuit; and wherein said positive and negative polarity convergence circuits further comprise a switching network.

13. A cathode ray tube convergence circuit as recited in claim 12, wherein said positive and said negative polarity convergence circuits each include a first rail and a second rail.

14. A cathode ray tube convergence circuit as recited in claim 13, wherein said first rails are low voltage rails, and said second rails are high voltage rails.

15. A cathode ray tube convergence circuit as recited in claim 12, wherein said positive polarity convergence circuit outputs high and low voltages to deflection yokes of the cathode ray tube.

16. A cathode ray tube convergence circuit as recited in claim 15, wherein said negative polarity convergence circuit outputs high and low voltages to deflection yokes of the cathode ray tube.

17. A cathode ray tube convergence circuit as recited in claim 12, wherein said boost-on-demand circuit outputs a high voltage to drive at least one convergence yoke for a relatively short time duration so that output power is conserved.

18. A cathode ray tube convergence circuit as recited in claim 17, wherein said boost-on-demand circuit outputs a low voltage for approximately 75% of an operating time of the cathode ray tube.
